(19) United States
(12) Patent Application Publication
(10) Pub. No.: US 2011/0066423 A1
(43) Pub. Date: Mar. 17, 2011

(54) Speech-Recognition System for Location-Aware Applications

(75) Inventors: George William Erhart, Loveland, CO (US); Valentine C. Matula, Granville, OH (US); David Joseph Skiba, Golden, CO (US)

(73) Assignee: AVAYA INC., Basking Ridge, NJ (US)

(21) Appl. No.: 12/561,459

(22) Filed: Sep. 17, 2009

(51) Int. Cl. G06F 17/20; G10L 15/18

(52) U.S. Cl. 704/8; 704/257; 704/E15.001

(57) ABSTRACT

An apparatus and associated methods are disclosed that enable a speech-recognition system to perform functions related to the geo-locations of wireless telecommunications terminal users. In accordance with the illustrative embodiment, a geo-spatial grammar is employed that comprises rules concerning the geo-locations of users, and a speech-recognition system uses the geo-spatial grammar to estimate the geo-locations of wireless telecommunications terminal users and generate actions in location-aware applications, in addition to its usual function of identifying words and phrases in spoken language. The present invention is advantageous in a variety of location-aware applications, such as interactive voice response (IVR) systems, voice-activated navigation systems, voice search, and voice dialing.

### FIELD OF THE INVENTION

The present invention relates to speech recognition in general, and, more particularly, to a speech-recognition system for location-aware applications.

### BACKGROUND OF THE INVENTION

Speech recognition is the ability of a machine or program to identify words and phrases in spoken language and convert them to a machine-readable format. Applications of speech recognition include call routing, speech-to-text, voice dialing, and voice search.

FIG. 1 depicts the salient elements of speech-recognition system 100, in accordance with the prior art. As shown in FIG. 1, speech-recognition system 100 comprises feature extractor 101, acoustic modeler 102, and decoder 103, interconnected as shown.

Feature extractor 101 comprises software, hardware, or both, that is capable of receiving an input electromagnetic signal that represents speech (e.g., a signal obtained from a user speaking into a microphone, etc.) and of extracting features (e.g., phonemes, etc.) from the input signal (e.g., via signal processing techniques, etc.)

Acoustic modeler 102 comprises software, hardware, or both, that is capable of receiving features generated by feature extractor 101 and of applying an acoustic model (e.g., a Gaussian statistical model, a Markov chain-based model, etc.) to the features.

Decoder 103 comprises software, hardware, or both, that is capable of receiving output from acoustic modeler 102, and of generating output in a particular language based on the output from acoustic modeler 102, a lexicon for the language, and a grammar for the language. For example, the lexicon might be a subset of the English language (e.g., a set of relevant English words for a particular domain, etc.), and the grammar might be a context-free grammar comprising the following rules:

SENTENCE->NOUN-PHRASE VERB-PHRASE

NOUN-PHRASE->ARTICLE NOUN|ARTICLE ADJECTIVE NOUN|NOUN

VERB-PHRASE->VERB ADVERB|VERB

Alternatively, the grammar might be a statistical grammar that predicts the probability with which a word or phrase is followed by another word or phrase (e.g., the probability that the phrase “Voice over” is followed by the phrase “IP” might be 0.7, etc.)

### SUMMARY OF THE INVENTION

The present invention enables a speech-recognition system to perform functions related to the geo-locations of wireless telecommunications terminal users via the use of a geo-spatial grammar—either in addition to, or instead of, its typical speech-recognition functions. In particular, in accordance with the illustrative embodiment, a geo-spatial grammar is employed that comprises a plurality of rules concerning the geo-locations of users, and a speech-recognition system uses the geo-spatial grammar to generate actions in a location-aware application, as well as to estimate the geo-locations of wireless telecommunications terminal users themselves.

For example, in accordance with the illustrative embodiment, a geo-spatial grammar might comprise a rule that indicates that a user typically eats lunch between noon and 1:00 pm, in which case a speech-recognition system using this grammar might generate an action in a location-aware application that notifies the user when he or she is within two miles of a pizza parlor during the 12:00-1:00 pm hour. As another example, a geo-spatial grammar might comprise one or more rules regarding the movement of users, in which case a speech-recognition system using this grammar might provide an estimate of the geo-location of a user when that user's wireless telecommunications terminal is unable to receive sufficient Global Positioning System (GPS) signals (e.g., in an urban canyon, etc.).

The present invention thus provides an improved speech-recognition system that is capable of estimating the geo-location of users and of generating pertinent actions in a location-aware application, in addition to its usual function of identifying words and phrases in spoken language. Such a speech-recognition system is advantageous in a variety of location-aware applications, such as interactive voice response (IVR) systems, voice-activated navigation systems, voice search, voice dialing, and so forth.

The illustrative embodiment comprises: a feature extractor for extracting features from an electromagnetic signal that represents speech; and a decoder for generating output in a language based on: (i) output from the feature extractor, (ii) the contents of a lexicon for the language, and (iii) a first grammar that is for the language; and WHEREIN THE IMPROVEMENT COMPRISES: the decoder is also for generating actions for a location-aware application based on a second grammar; and wherein the second grammar comprises one or more rules concerning the geo-locations of one or more users.

### BRIEF DESCRIPTION OF THE DRAWINGS

FIG. 1 depicts the salient elements of a speech-recognition system, in accordance with the prior art.

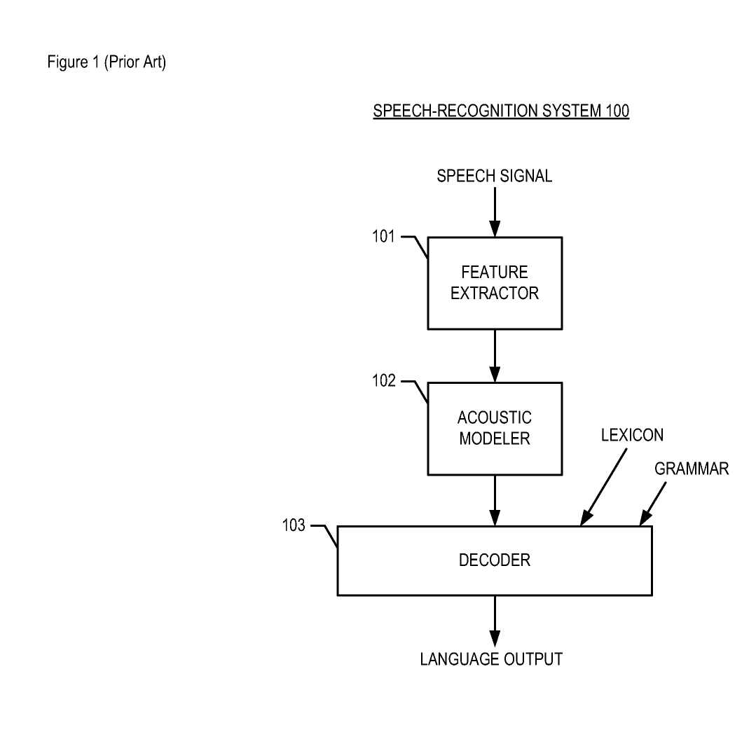

FIG. 2 depicts the salient elements of a speech-recognition system, in accordance with the illustrative embodiment of the present invention.

FIG. 3 depicts a flowchart of the salient tasks of a first method performed by speech-recognition system 200, as shown in FIG. 2, in accordance with the illustrative embodiment of the present invention.

FIG. 4 depicts a flowchart of the salient tasks of a second method performed by speech-recognition system 200, in accordance with the illustrative embodiment of the present invention.

### DETAILED DESCRIPTION

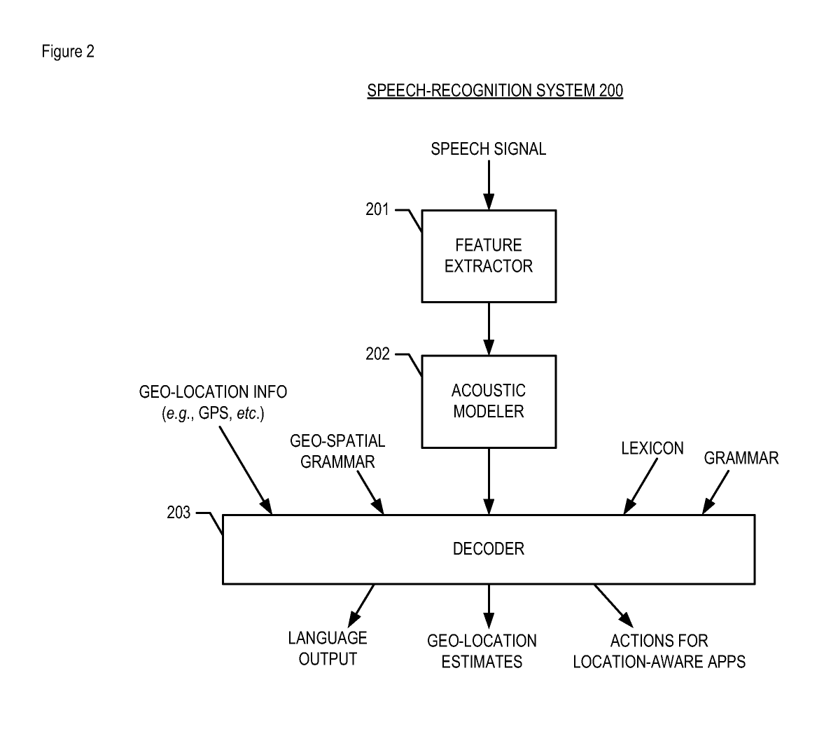

FIG. 2 depicts the salient elements of speech-recognition system 200, in accordance with the illustrative embodiment of the present invention. As shown in FIG. 2, speech-recognition system 200 comprises feature extractor 201, acoustic modeler 202, and decoder 203, interconnected as shown.

Feature extractor 201 comprises software, hardware, or both, that is capable of receiving an input electromagnetic signal that represents speech (e.g., a signal obtained from a user speaking into a microphone, etc.) and of extracting features (e.g., phonemes, etc.) from the input signal (e.g., via signal processing techniques, etc.).

Acoustic modeler 202 comprises software, hardware, or both, that is capable of receiving features generated by feature extractor 201 and of applying an acoustic model (e.g., a Gaussian statistical model, a Markov chain-based model, etc.) to the features.

Decoder 203 comprises software, hardware, or both, that is capable of:
(i) receiving output from acoustic modeler 202;
(ii) generating output in a particular language (e.g., English, etc.) based on:
   output from acoustic modeler 202,
   a lexicon for the language, and
   a grammar for the language;
(iii) receiving information regarding the geo-location of one or more telecommunications terminal users (e.g., current GPS geo-location estimates, prior geo-location estimates, historical geo-location information, etc.);
(iv) receiving information regarding the geo-location of one or more telecommunications terminal users (e.g., current GPS geo-location estimates, prior geo-location estimates, historical geo-location information, etc.);
(v) matching and firing rules in a geo-spatial grammar, based on:
   the received geo-location information,
   the calendrical time, and
   the contents of one or more calendars;
(vi) estimating the current geo-location of one or more users in accordance with fired rules of the geo-spatial grammar; and
(vii) generating actions in one or more location-aware applications in accordance with fired rules of the geo-spatial grammar.

For example, a geo-spatial grammar might have one or more of the following rules for estimating current or future user geo-locations:
a particular user is typically in the corporate cafeteria between noon and 1:00 pm on weekdays;
a particular user takes a particular car route home from work;
vehicles at a particular traffic intersection typically make a right turn;
if a user's current geo-location is unknown (e.g., the user's terminal is not receiving a sufficient number of GPS satellite signals, etc.), consult one or more calendars for an entry that might indicate a likely geo-location for that user.

Similarly, a geo-spatial grammar might have one or more of the following rules for generating actions in location-aware applications:
if a user is within 100 yards of a friend, generate an alert to notify the user;
if a user is in a schoolyard, enable a website filter on the user's terminal;
if a user says the word “Starbucks,” display a map that shows all nearby Starbucks locations;
if a user is inside a book store, automatically launch the terminal's browser and go to the Amazon.com website (presumably so that the user can easily perform a price check on an item).

In accordance with the illustrative embodiment, input to the geo-spatial grammar is represented as a vector comprising a plurality of data related to geo-location, such as time, latitude, longitude, altitude, direction, speed, rate of change in altitude, ambient temperature, rate of change in temperature, ambient light level, ambient noise level, etc. As will be appreciated by those skilled in the art, in some other embodiments the vector might comprise other data instead of, or in addition to, those of the illustrative embodiment, and it will be clear to those skilled in the art, after reading this disclosure, how to make and use such embodiments of the present invention.

As will further be appreciated by those skilled in the art, in some embodiments of the present invention, the algorithms employed by decoder 302 to generate output in a particular language (i.e., tasks (i) and (ii) above) might be different than those employed for the processing related to the geo-spatial grammar (i.e., tasks (iii) through (vii) above), while in some other embodiments, some or all of these algorithms might be employed by decoder 302 for both purposes. As will yet further be appreciated by those skilled in the art, in some embodiments of the present invention, the grammar for the language and the geo-spatial grammar might be different types of grammars (e.g., a statistical grammar for the language and a context-free geo-spatial grammar, etc.), while in some other embodiments, the same type of grammar might be employed for both purposes.

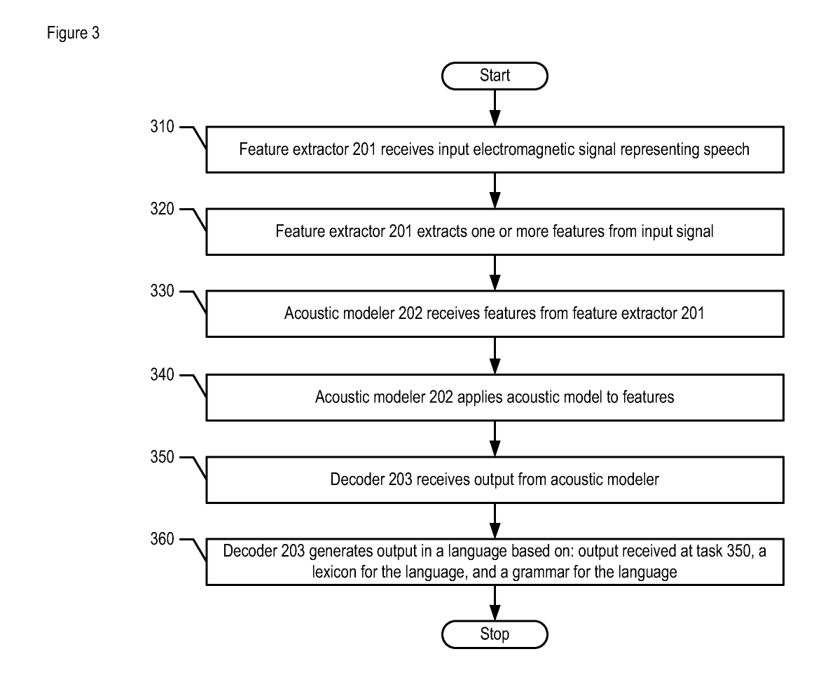

FIG. 3 depicts a flowchart of the salient tasks of a first method performed by speech-recognition system 200, in accordance with the illustrative embodiment of the present invention. It will be clear to those skilled in the art, after reading this disclosure, which tasks depicted in FIG. 3 can be performed simultaneously or in a different order than that depicted.

At task 310, feature extractor 201 receives an input electromagnetic signal representing speech, in well-known fashion.

At task 320, feature extractor 201 extracts one or more features (e.g., phonemes, etc.) from the input signal received at task 310, in well-known fashion.

At task 330, acoustic modeler 202 receives the features extracted at task 320 from feature extractor 201, in well-known fashion.

At task 340, acoustic modeler 202 applies an acoustic model (e.g., a Gaussian statistical model, a Markov chain-based model, etc.) to the features received at task 330, in well-known fashion.

At task 350, decoder 203 receives output from acoustic modeler 202, in well-known fashion.

At task 360, decoder 203 generates output in a language based on the output received at task 350, a lexicon for the language, and a grammar for the language, in well-known fashion.

After task 360, the method of FIG. 3 terminates.

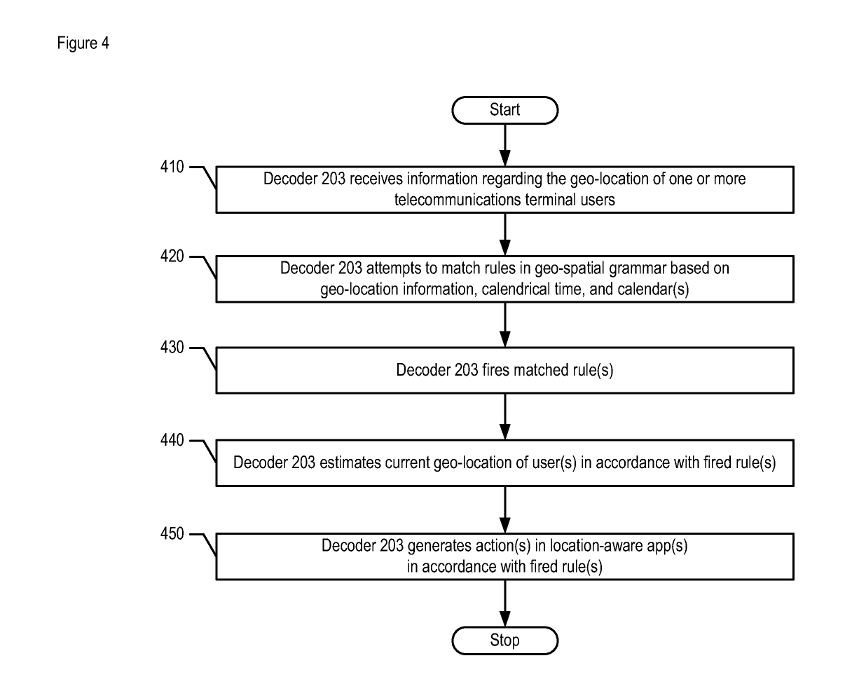

FIG. 4 depicts a flowchart of the salient tasks of a second method performed by speech-recognition system 200, in accordance with the illustrative embodiment of the present invention. It will be clear to those skilled in the art, after reading this disclosure, which tasks depicted in FIG. 4 can be performed simultaneously or in a different order than that depicted.

At task 410, decoder 203 receives information regarding the geo-location of one or more telecommunications terminal users (e.g., current GPS geo-location estimates, prior geo-location estimates, historical geo-location information, etc.).

At task 420, decoder 203 attempts to match rules in a geo-spatial grammar based on the geo-location information received at task 410, the calendrical time, and the contents of one or more calendars.

At task 430, decoder 203 fires one or more matched rules, in well-known fashion.

At task 440, decoder 203 estimates the current geo-location of one or more users, in accordance with the rules fired at task 430.

At task 450, decoder 203 generates one or more actions in one or more location-aware applications, in accordance with the rules fired at task 430.

After task 450, the method of FIG. 4 terminates.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A speech-recognition system comprising:
a feature extractor for extracting features from an electromagnetic signal that represents speech; and
a decoder for generating output in a language based on:
(i) output from said feature extractor,
(ii) the contents of a lexicon for said language, and
(iii) a first grammar that is for said language; and
WHEREIN THE IMPROVEMENT COMPRISES:
said decoder is also for generating actions for a location-aware application based on a second grammar; and
wherein said second grammar comprises one or more rules concerning the geo-locations of one or more users.

2. The speech-recognition system of claim 1 wherein said second grammar comprises a rule for generating an action for said location-aware application based on the current geo-location of one or more users.

3. The speech-recognition system of claim 2 wherein said second grammar comprises a rule for generating an action for said location-aware application based on the proximity of a first user to a second user.

4. The speech-recognition system of claim 2 wherein said second grammar comprises a rule for generating an action for said location-aware application based on the proximity of a user to a given geo-location.

5. The speech-recognition system of claim 2 wherein said second grammar comprises a rule for generating an action for said location-aware application based on whether one or more users are in a given area.

6. The speech-recognition system of claim 1 wherein said second grammar comprises a rule for generating an action for said location-aware application based on one or more prior geo-locations of one or more users.

7. The speech-recognition system of claim 1 wherein said second grammar comprises a rule that is based on the current geo-location of a user and the calendrical time at the current geo-location of said user.

8. The speech-recognition system of claim 1 wherein said second grammar comprises a rule that compares a geo-location of a user to an entry in a calendar.

9. The speech-recognition system of claim 1 wherein said location-aware application comprises handling calls based on the geo-locations of callers.

10. A speech-recognition system comprising:
a feature extractor for extracting features from an electromagnetic signal that represents speech; and
a decoder for generating output in a language based on:
(i) output from said feature extractor,
(ii) the contents of a lexicon for said language, and
(iii) a first grammar that is for said language; and
WHEREIN THE IMPROVEMENT COMPRISES:
said decoder is also for estimating a geo-location of a user U of a wireless telecommunications terminal T based on a second grammar; and
wherein said second grammar comprises one or more rules concerning the geo-locations of one or more users.

11. The speech-recognition system of claim 10 wherein said second grammar comprises a rule that is for said user U.

12. The speech-recognition system of claim 10 wherein said second grammar comprises a rule that is for a plurality of users.

13. The speech-recognition system of claim 10 wherein said second grammar comprises a rule that predicts a geo-location of a user based on a prior geo-location of said user.

14. The speech-recognition system of claim 10 wherein said second grammar comprises a rule that predicts a geo-location of a user of based on calendrical time.

15. The speech-recognition system of claim 10 wherein said second grammar comprises a rule that predicts a geo-location of a user based on an entry in a calendar.

16. A method comprising:
receiving at a speech-recognition system an electromagnetic signal that represents speech;
generating at said speech-recognition system output in a language, wherein said output is based on said electromagnetic signal and a first grammar for said language;
receiving at said speech-recognition system one or more signals concerning the geo-location of one or more users; and
generating at said speech-recognition system an action for a location-aware application based on a second grammar;
wherein said second grammar comprises one or more rules concerning the geo-locations of one or more users.

17. The method of claim 16 wherein said one or more signals are from a Global Positioning System receiver.

18. The method of claim 16 wherein said second grammar comprises a rule for generating an action for said location-aware application based on the current geo-location of one or more users.

19. The method of claim 16 wherein said second grammar comprises a rule for generating an action for said location-aware application based on one or more prior geo-locations of one or more users.

20. The method of claim 16 wherein said second grammar comprises a rule that compares a geo-location of a user to an entry in a calendar.
